(19) United States
(12) Patent Application Publication
(10) Pub. No.: US 2003/0094989 A1
(43) Pub. Date: May 22, 2003

(54) Multiplier

(76) Inventors: Yoshikatsu Matsugaki, Oita-shi (JP); Akinobu Morota, Oita-shi (JP)

Correspondence Address: TEXAS INSTRUMENTS INCORPORATED, P O BOX 655474, M/S 3999, DALLAS, TX, 75265

(21) Appl. No.: 10/289,673

(22) Filed: Nov. 7, 2002

(30) Foreign Application Priority Data
Nov. 7, 2001 (JP) 2001-342,348

(51) Int. Cl. G06G 7/16

(52) U.S. Cl. 327/356

(57) ABSTRACT

A multiplier usable for low-voltage operation with a simple constitution. Control is performed such that the sum of the emitter currents of a first transistor pair, which is composed of transistor Q13 and transistor Q14, and of transistor Q11 and the sum of the emitter currents of a second transistor pair, which is composed of transistor Q15 and transistor Q16, and of transistor Q12 are both equal to constant current Io. For said first transistor pair and second transistor pair, differential voltage v1 is input to the pair of bases, and, collector currents on corresponding sides that vary in opposite direction with respect to change in said differential voltage v1 are synthesized at terminal To and terminal To′, respectively. The synthesized current flows as a differential current in resistors R11 and R12. A signal corresponding to the product of differential voltage v2 and differential voltage v1 that are input between the bases of transistor Q11 and transistor Q12 is output from between terminal To and terminal To′.

### FIELD OF THE INVENTION

This invention pertains to a type of multiplier that performs multiplication to generate a signal as product of two input signals.

### BACKGROUND OF THE INVENTION

For example, the mixer circuit used in frequency converters and demodulators, etc. is often made of a circuit known as a Gilbert cell.

FIG. 5 is a schematic circuit diagram illustrating the basic constitution of said Gilbert cell.

In FIG. 5, Q1-Q6 represent npn transistors; CC1 represents a constant current circuit; R1 and R2 represent resistors; T1, T1′, T2, T2′, To and To′ represent terminals.

The emitters of npn transistor Q1 and npn transistor Q2 are connected to each other, and they are also connected to reference potential GND via constant current circuit CC1. The base of npn transistor Q1 is connected to terminal T1, and the base of npn transistor Q2 is connected to terminal T1′.

The emitters of npn transistor Q3 and npn transistor Q4 are connected to each other, and, at the same time, they are also connected to the collector of npn transistor Q1. Also, the base of npn transistor Q3 is connected to terminal T2, and the base of npn transistor Q4 is connected to terminal T2′.

The emitters of npn transistor Q5 and npn transistor Q6 are connected to each other, and, at the same time, they are also connected to the collector of npn transistor Q2. Also, the base of npn transistor Q5 is connected to terminal T2′, and the base of npn transistor Q6 is connected to terminal T2.

The collectors of npn transistor Q3 and npn transistor Q5 are connected to each other and to terminal To, and, at the same time, they are also connected through resistor R1 to power source Vcc.

The collectors of npn transistor Q4 and npn transistor Q6 are connected to each other and to terminal To′, and, at the same time, they are also connected through resistor R2 to power source Vcc.

Constant voltage V1 is input as an in-phase voltage to terminal T1 and terminal T1′, and signal v1 is input to them as a differential voltage.

Constant voltage V2 is input as an in-phase voltage to terminal T2 and terminal T2′, and signal v2 is input to them as a differential voltage.

In the Gilbert cell shown in FIG. 5 with said constitution, the following relationship is established between input differential voltages v1 and v2 and output differential voltage vo.

$${v}_{0} = {v}_{01} - {v}_{02} = tanh ( \frac{{v}_{1}}{2 {V}_{T}} ) \cdot tanh ( \frac{{v}_{2}}{2 {V}_{T}} ) \cdot {I}_{0} \cdot {R}_{L} \qquad ( 1 )$$

In Equation (1), RL represents the resistance values of resistors R1 and R2, and VT represents the thermal voltage of the npn transistor.

Thermal voltage VT is the following function of Boltzmann constant k, temperature T of the junction portion of a transistor, and electron charge q: VT=kT/q

For example, assuming that the junction temperature T is 300K, it is about 26 mV.

First of all, in Equation (1), when input differential voltage v1 and input differential voltage v2 are much smaller than said thermal voltage VT, that is, when |v1/2VT|<<1 and |v2/2VT|<<1, one has

tanh(v1/2VT)≈v1/2VT

tanh(v2/2VT)≈v2/2VT

Consequently, Equation (1) can be approximately rewritten as follows.

$${v}_{0} = {v}_{01} - {v}_{02} = ( \frac{{v}_{1}}{2 {V}_{T}} ) \cdot ( \frac{{v}_{2}}{2 {V}_{T}} ) \cdot {I}_{0 \\} \cdot {R}_{L} = \frac{{I}_{0} \cdot {R}_{L}}{4 \cdot {( {V}_{T} )}^{2}} ( {v}_{1} \cdot {v}_{2} ) \qquad ( 2 )$$

As can be seen from Equation (2), output differential voltage vo is proportional to the product of input differential voltage v1 and input differential voltage v2, that is, the Gilbert cell shown in FIG. 5 functions as a multiplier.

Also, for the Gilbert cell shown in FIG. 5, usually, one of the input signals is a small signal, while the other input signal is a large signal. Consequently, consider the case when |v1/2VT|<<1 and |v2/2VT|>>1.

First of all, when v2/2VT >>1, one has

tanh(v2/2VT)≈1

Consequently, Equation (1) can be approximately rewritten as follows.

$${v}_{0} = ( \frac{{I}_{0} \cdot {R}_{L}}{2 {V}_{T}} ) \cdot {v}_{1} when {v}_{2} / 2 {V}_{T} ⪢ 1 \qquad ( 3 )$$

When v2/2VT <<−1, one has

tanh(v2/2VT)≈−1

Consequently, Equation (1) can be approximately rewritten as follows.

$${v}_{0} = ( \frac{{I}_{0} \cdot {R}_{L}}{2 {V}_{T}} ) \cdot {v}_{1} when {v}_{2} / 2 {V}_{T} ⪡ - 1 \qquad ( 4 )$$

As can be seen from Equations (3) and (4), the magnitude of output differential voltage vo is proportional to input differential voltage v1, and the sign of output differential voltage vo is inverted corresponding to the sign of input differential voltage v2. This is equivalent to multiplying output differential voltage vo with a value of “+1” or “−1”, depending on the sign of input differential voltage v2. Consequently, even in this case, the Gilbert cell shown in FIG. 5 still functions as a multiplier.

However, for said Gilbert cell shown in FIG. 5, there are the following problems.

For the Gilbert cell shown in FIG. 5, for example, when constant current source CC1 is made of a conventional current mirror circuit, the maximum amplitude ΔVomax of the output signal that can be taken from terminal To or To′ is as follows:

ΔVomax≦Vcc−3Vce

Here, Vce represents the collector-emitter voltage of the npn transistor. In order to have the transistor operate in a unsaturated state with high stability, said collector-emitter voltage Vce usually should be about 1 V. For example, assuming that power source Vcc=5 V, collector-emitter voltage Vce=1 V, the maximum amplitude of the output signal, ΔVomax, becomes

ΔVomax≦5−3×1=2 (V)

Under the same condition, assuming that power source Vcc=3V, one has

ΔVomax≦3−3×1=0 (V)

Consequently, when power source Vcc=3 V, the Gilbert cell cannot operate with high stability.

Consequently, for the Gilbert cell circuit shown in FIG. 5, stable operation cannot be realized as a low-voltage circuit with a power source voltage of 3 V or lower. This is a problem. On the other hand, in recent years, an ever increasing demand for lowering the voltage of semiconductor integrated circuits has existed. Consequently, a demand exists for development of a type of multiplier that can operate at a power source voltage lower than that of said Gilbert cell circuit.

In the prior art, circuits shown in FIGS. 6 and 7 have been proposed as multipliers that can work under a low voltage.

FIG. 6 is a circuit diagram illustrating an example of a conventional multiplier that can work at a power source voltage lower than that of the Gilbert cell.

The same part numbers are used for FIGS. 5 and 6. Also, Q1′ and Q2′ represent pnp transistors, and CC2-CC4 represent constant current circuits.

For the multiplier shown in FIG. 6, instead of the differential amplifier composed of npn transistor Q1, npn transistor Q2 and constant current circuit CC1 shown in FIG. 5, a differential amplifier composed of pnp transistor Q′, pnp transistor Q2′ and constant current circuit CC4 is set.

That is, the emitters of pnp transistor Q1′ and pnp transistor Q2′ are connected to each other, and, at the same time, they are connected through constant current circuit CC4 to power source Vcc. The collector of pnp transistor Q1′ is connected to the emitters of npn transistor Q3 and npn transistor Q4 that are connected to each other, and its base is connected to terminal T2. The collector of pnp transistor Q2′ is connected to the emitters of npn transistor Q5 and npn transistor Q6 that are connected to each other, and its base is connected to terminal T2′. Constant voltage V2 is input as an in-phase voltage to terminals T2 and T2′, and signal v2 is input as a differential voltage to these terminals.

Also, the emitters of npn transistor Q3 and npn transistor Q4 that are connected to each other are connected through constant current circuit CC2 to reference voltage GND. The emitters of npn transistor Q5 and npn transistor Q6 that arc connected to each other are connected through constant current circuit CC3 to reference potential GND.

For the multiplier shown in FIG. 6 with the aforementioned constitution, when conventional current mirror circuits are used to form constant current circuits CC2 and CC3, the maximum amplitude of the output signal, ΔVomax, becomes

ΔVomax≦Vcc−2Vce

The amplitude of the output signal is larger than that of the Gilbert cell shown in FIG. 5 by collector-emitter voltage Vce of one transistor. In other words, the multiplier can work with high stability at a power source voltage lower by this voltage than that needed for the Gilbert cell.

FIG. 7 is a circuit diagram illustrating another example of the conventional multiplier that can work at a power source voltage lower than that of the Gilbert cell.

The part numbers for FIG. 7 are the same as those for FIG. 6. Also, Q7 and Q8 represent npn transistors, CC7-CC9 represent constant current circuits, and CV1 and CV2 represent constant voltage circuits.

For the multiplier shown in FIG. 7, instead of the differential amplifier composed of pnp transistor Q1′, pnp transistor Q2′ and constant current circuit CC4 shown in FIG. 6, a differential amplifier composed of npn transistor Q7, npn transistor Q8, and constant current circuits CC7-CC9 is set.

That is, the emitters of npn transistor Q7 and npn transistor Q8 are connected to each other, and, at the same time, they are connected through constant current circuit CC7 to reference potential GND. The collector of npn transistor Q7 is connected through constant current circuit CC8 to power source Vcc, and its base is connected to terminal T2. The collector of npn transistor Q8 is connected through constant current circuit CC9 to power source Vcc, and its base is connected to terminal T2′. Constant voltage V2 is input as an in-phase voltage to terminals T2 and T2′, and signal v2 is input as a differential voltage to these terminals.

Also, the collector of npn transistor Q7 is connected through constant voltage circuit CV1 to the emitters of npn transistor Q3 and npn transistor Q4 that are connected to each other. The collector of npn transistor Q8 is connected through constant voltage circuit CV2 to the emitters of npn transistor Q5 and npn transistor Q6 that are connected to each other.

For the multiplier shown in FIG. 7 with the aforementioned constitution, when conventional current mirror circuits are used to form constant current circuits CC2 and CC3, the maximum amplitude of the output signal, ΔVomax, becomes

ΔVomax≦Vcc−2Vce

The amplitude of the output signal is larger than that of the Gilbert cell shown in FIG. 5 by collector-emitter voltage Vce of one transistor. In other words, the multiplier can work with high stability at a power source voltage lower by this voltage than that needed for the Gilbert cell.

However, for the conventional low-voltage multipliers shown in FIGS. 6 and 7, there are the following problems.

For the multiplier shown in FIG. 6, it is necessary to use pnp transistors. Consequently, as compared with a Gilbert cell that uses only npn transistors, the frequency characteristics are worse.

Also, for the multipliers shown in FIGS. 6 and 7, current sources have to be set on both the power source Vcc side and the reference potential GND side. Also, it is necessary for the two current values to be in agreement with each other at high precision. Consequently, a complex circuit has to be set. In addition, these multipliers have more constant current circuits and constant voltage circuits than the Gilbert cell shown in FIG. 5. Consequently, the circuit becomes complicated. This is undesired.

A general object of this invention is to solve the aforementioned problems of conventional methods by providing a type of multiplier that can perform a multiplication operation at a power source voltage lower than that of the Gilbert cell. Another general object of this invention is to provide a type of multiplier that can perform a multiplication operation at a power source voltage lower than that of the Gilbert cell, without using pnp transistors.

### SUMMARY OF THE INVENTION

These and other objects and features are attained, in accordance with an aspect of this invention comprising: a first transistor pair having a first transistor and a second transistor on which a first differential signal is applied; a second transistor pair having a third transistor and a fourth transistor on which said first differential signal is applied; a fifth transistor on which one signal of a second differential signal is applied; a sixth transistor on which the other signal of said second differential signal is applied; a first current feeding circuit for feeding current to said first transistor, second transistor, and fifth transistor; a second current feeding circuit for feeding current to said third transistor, fourth transistor and sixth transistor; a first resistor connected to said first transistor and fourth transistor having said first differential signal applied on them; and a second resistor connected to said second transistor and third transistor having said first differential signal applied on them.

Also, in accordance with another aspect of the invention the multiplier preferably has the following parts: a third resistor connected between said first transistor and said first current feeding circuit; a fourth resistor connected between said second transistor and said first current feeding circuit; a fifth resistor connected between said third transistor and said second current feeding circuit; and a sixth resistor connected between said fourth transistor and said second current feeding circuit.

In addition, in accordance with a further aspect of the invention the multiplier preferably has a seventh resistor connected between said fifth transistor and said first current feeding circuit, and an eighth resistor connected between said sixth transistor and said second current feeding circuit.

Also, in accordance with yet another aspect of the multiplier of this invention, said first and second current feeding circuits are preferably constant current circuits.

### BRIEF DESCRIPTION OF THE DRAWINGS

FIG. 1 is a schematic circuit diagram illustrating a constitution example of a multiplier in an embodiment of this invention.

FIG. 2 is a schematic circuit diagram illustrating a constitution example that can expand the range of input of the first differential voltage in the multiplier shown in FIG. 1.

FIG. 3 is a schematic circuit diagram illustrating a constitution example that can expand the range of input of the second differential voltage in the multiplier shown in FIG. 2.

FIG. 4 is a schematic circuit diagram illustrating a constitution example that has constant current circuits replaced with resistors in the multiplier shown in FIG. 1.

FIG. 5 is a schematic circuit diagram illustrating the basic constitution of a Gilbert cell.

FIG. 6 is a circuit diagram illustrating an example of a prior art multiplier that can work at a power source voltage lower than that of the Gilbert cell.

FIG. 7 is a circuit diagram illustrating another example of a prior art multiplier that can work at a power source voltage lower than that of the Gilbert cell.

### REFERENCE NUMERALS AND SYMBOLS AS SHOWN IN THE DRAWINGS

In the figures, Q1-Q16 represent npn transistors, CC1-CC12 constant current circuits, R1-R20 resistors, T1, T1′, T2, T2′, To, To′ terminals, and CV1, CV2 constant voltage circuits.

### DESCRIPTION OF EMBODIMENTS

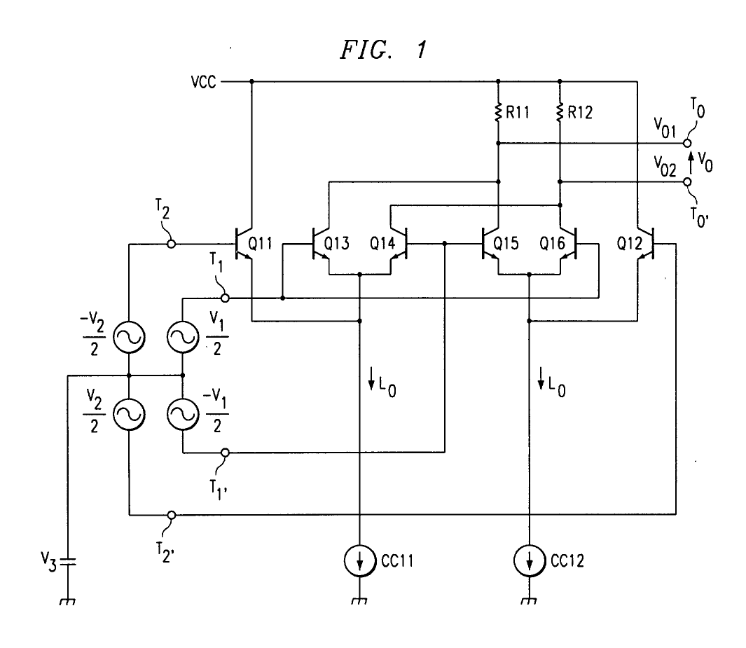

In the following, embodiments of this invention will be considered with reference to FIGS. 1-4.

FIG. 1 is a schematic circuit diagram illustrating an example of a multiplier in an embodiment of this invention.

In FIG. 1, Q11-Q16 represent npn transistors, CC11 and CC12 represent constant current circuits, R11 and R12 represent resistors, and T1, T1′, T2, T2′, To and To′ represent terminals.

The emitters of npn transistor Q11, npn transistor Q13 and npn transistor Q14 are connected with each other, and, at the same time, they are connected through constant current circuit CC11 to reference potential GND.

The emitters of npn transistor Q12, npn transistor Q15 and npn transistor Q16 are connected to each other, and, at the same time, they are connected through constant current circuit CC12 to reference potential GND.

The collectors of npn transistor Q13 and npn transistor Q15 are connected to each other and to terminal To, and, at the same time, they are connected through resistor R11 to power source Vcc.

The collectors of npn transistor Q14 and npn transistor Q16 are connected to each other and to terminal To′, and, at the same time, they are connected through resistor R12 to power source Vcc.

The base of npn transistor Q11 is connected to terminal T2, and its collector is connected to power source Vcc.

The base of npn transistor Q12 is connected to terminal T2′, and its collector is connected to power source Vcc.

The bases of npn transistor Q13 and npn transistor Q16 are connected to each other, and, at the same time, they are connected to terminal T1.

The bases of npn transistor Q14 and npn transistor Q15 are connected to each other, and, at the same time, they are connected to terminal T1′.

Constant voltage V3 is input as an in-phase voltage to terminals T1 and T1′, and signal v1 is input as a differential signal to said terminals.

Constant voltage V3 is input as an in-phase voltage to terminals T2 and T2′, with the same voltage applied on terminals T1 and T1′, and signal v2 is input as a differential signal to said terminals.

In the following, the function of multiplication of the multiplier with said constitution will be considered.

Assuming that the base-emitter voltages of npn transistor Q11-npn transistor Q16 are voltages Vbe1-Vbe6, and the emitter currents are currents Ic1-Ic6, the following approximate relationships are established.

$$\begin{matrix}{I}_{1} \approx {I}_{s} \cdot exp ( \frac{{Vbe}_{1}}{{V}_{T}} ) & ( 5 ) \\ {I}_{2} \approx {I}_{s} \cdot exp ( \frac{{Vbe}_{2}}{{V}_{T}} ) & ( 6 ) \\ {I}_{3} \approx {I}_{s} \cdot exp ( \frac{{Vbe}_{3}}{{V}_{T}} ) & ( 7 ) \\ {I}_{4} \approx {I}_{s} \cdot exp ( \frac{{Vbe}_{4}}{{V}_{T}} ) & ( 8 ) \\ {I}_{5} \approx {I}_{s} \cdot exp ( \frac{{Vbe}_{5}}{{V}_{T}} ) & ( 9 ) \\ {I}_{6} \approx {I}_{s} \cdot exp ( \frac{{Vbe}_{6}}{{V}_{T}} ) & ( 10 )\end{matrix}$$

Here, Is represents a saturated current.

Also, because the current as a sum of the emitter currents of npn transistor Q11, npn transistor Q13 and npn transistor Q14 is set as constant current Io by means of constant current circuit CC11, the following equation is obtained.

$$\begin{matrix}{I}_{0} = {I}_{1} + {I}_{3} + {I}_{4} \\ = {I}_{s} \{ exp ( \frac{{Vbe}_{1}}{{V}_{T}} ) + exp ( \frac{{Vbe}_{3}}{{V}_{T}} ) + exp ( \frac{{Vbe}_{4}}{{V}_{T}} ) \} \\ = {I}_{s} \cdot exp ( \frac{{Vbe}_{4}}{{V}_{T}} ) \{ exp ( \frac{{Vbe}_{1} - {Vbe}_{4}}{{V}_{T}} ) + exp ( \frac{{Vbe}_{3} - {Vbe}_{4}}{{V}_{T}} ) + 1 \}\end{matrix} \qquad ( 11 )$$

On the other hand, for the voltage difference between voltage Vbe3 and voltage Vbe4 and the voltage difference between voltage Vbe1 and voltage Vbe4, the following relationships are established.

Vbe₃−Vbe₄=v₁ (12)

$${Vbe}_{1} - {Vbe}_{4} = \frac{- {v}_{2} + {v}_{1}}{2} \qquad ( 13 )$$

By substituting Equations (12) and (13) into Equation (11) and rearranging, one gets the following equation.

$$exp ( \frac{{Vbe}_{4}}{{V}_{T}} ) = \frac{{I}_{o}}{{I}_{s}} \cdot \frac{1}{exp ( \frac{{v}_{1} - {v}_{2}}{2 {V}_{T}} ) + exp ( \frac{{v}_{1}}{{V}_{T}} ) + 1} \qquad ( 14 )$$

Similarly, because the current as a sum of the emitter currents of npn transistor Q12, npn transistor Q15 and npn transistor Q16 is set as constant current Io by means of constant current circuit CC12, the following equation is obtained.

$$\begin{matrix}{I}_{o} = {I}_{2} + {I}_{5} + {I}_{6} \\ = {I}_{s} \{ exp ( \frac{{Vbe}_{2}}{{V}_{T}} ) + exp ( \frac{{Vbe}_{5}}{{V}_{T}} ) + exp ( \frac{{Vbe}_{6}}{{V}_{T}} ) \} \\ = {I}_{s} \cdot exp ( \frac{{Vbe}_{5}}{{V}_{T}} ) \{ exp ( \frac{{Vbe}_{2} - {Vbe}_{5}}{{V}_{T}} ) + exp ( \frac{{Vbe}_{6} - {Vbe}_{5}}{{V}_{T}} ) + 1 \}\end{matrix} \qquad ( 15 )$$

On the other hand, for the voltage difference between voltage Vbe6 and voltage Vbe5 and the voltage difference between voltage Vbe2 and voltage Vbe5, the following relationships are established.

Vbe₆−Vbe₅=v₁ (16)

$${Vbe}_{2} - {Vbe}_{5} = \frac{{v}_{1} + {v}_{2}}{2} \qquad ( 17 )$$

By substituting Equations (16) and (17) into Equation (15) and rearranging, one gets the following equation.

$$exp ( \frac{{Vbe}_{5}}{{V}_{T}} ) = \frac{{I}_{0}}{{I}_{s}} \cdot \frac{1}{exp ( \frac{{v}_{1} + {v}_{2}}{2 {V}_{T}} ) + exp ( \frac{{v}_{1}}{{V}_{T}} ) + 1} \qquad ( 18 )$$

Also, the differential current between current I11 flowing in resistor R11 and current I12 flowing in resistor R12 can be represented by the following equation by means of Equations (7)-(10).

$$\begin{matrix}{I}_{12} - {I}_{11} = ( {I}_{4} + {I}_{6} ) - ( {I}_{3} + {I}_{5} ) \\ = Is \{ exp ( \frac{{Vbe}_{4}}{{V}_{T}} ) - exp ( \frac{{Vbe}_{3}}{{V}_{T}} ) - exp ( \frac{{Vbe}_{5}}{{V}_{T}} ) + exp ( \frac{{Vbe}_{6}}{{V}_{T}} ) \}\end{matrix} \qquad ( 19 )$$

On the other hand, base-emitter voltage Vbe6 of npn transistor Q16 is represented by the following equation.

Vbe₆=Vbe₃−Vbe₄+Vbe₅ (20)

By substituting said Equation (20) into Equation (19) and rearranging, one gets the following equation.

$$\begin{matrix}{I}_{12} - {I}_{11} = {I}_{s} \{ exp ( \frac{{Vbe}_{4}}{{V}_{T}} ) - exp ( \frac{{Vbe}_{3}}{{V}_{T}} ) \} \{ 1 - exp ( \frac{{Vbe}_{5} - {Vbe}_{4}}{{V}_{T}} ) \} \\ = {I}_{s} \{ 1 - exp ( \frac{{Vbe}_{3} - {Vbe}_{4}}{{V}_{T}} ) \} \{ exp ( \frac{{Vbe}_{4}}{{V}_{T}} ) - exp ( \frac{{Vbe}_{5}}{{V}_{T}} ) \}\end{matrix} \qquad ( 21 )$$

By substituting Equations (14) and (18) into said Equation (21), one gets

$${I}_{12} - {I}_{11} = {I}_{o} \cdot \{ 1 - exp ( \frac{{v}_{1}}{{V}_{T}} ) \} \{ \frac{1}{exp ( \frac{{v}_{1} - {v}_{2}}{{V}_{T}} ) + exp ( \frac{{v}_{1}}{{V}_{T}} ) + 1} - \frac{1}{exp ( \frac{{v}_{1} + {v}_{2}}{{V}_{T}} ) + exp ( \frac{{v}_{1}}{{V}_{T}} ) + 1} \} = {I}_{o} \{ exp ( \frac{- {v}_{1}}{2 {V}_{T}} ) - exp ( \frac{{v}_{1}}{2 {V}_{T}} ) \} \cdot \frac{exp ( \frac{{v}_{2}}{2 {V}_{T}} ) - exp ( \frac{- {v}_{2}}{2 {V}_{T}} )}{\{ exp ( \frac{- {v}_{2}}{2 {V}_{T}} ) + exp ( \frac{{v}_{1}}{2 {V}_{T}} ) + exp ( \frac{- {v}_{1}}{2 {V}_{T}} ) \} \{ exp ( \frac{{v}_{2}}{2 {V}_{T}} ) + exp ( \frac{{v}_{1}}{2 {V}_{T}} ) + exp ( \frac{- {v}_{1}}{2 {V}_{T}} ) \}} \qquad ( 22 )$$

In addition, Equation (22) can be rearranged using the following hyperbolic functions.

$$\begin{matrix}sinh ( x ) = \frac{exp ( x ) - exp ( - x )}{2} & ( 23 ) \\ cosh ( x ) = \frac{exp ( x ) + exp ( - x )}{2} & ( 24 )\end{matrix}$$

Applying Equations (23) and (24) to rearrange Equation (22), one gets the following equation.

$${I}_{12} - {I}_{11} = \frac{- 4 \cdot sinh ( \frac{{v}_{1}}{2 {V}_{T}} ) \cdot sinh ( \frac{{v}_{2}}{2 {V}_{T}} ) \cdot {I}_{o}}{4 \cdot {( [ cosh ( \frac{{v}_{1}}{2 {V}_{T}} ) ] )}^{2} + 4 \cdot cosh ( \frac{{v}_{1}}{2 {V}_{T}} ) \cdot cosh ( \frac{{v}_{2}}{2 {V}_{T}} ) + 1} \qquad ( 25 )$$

Using said Equation (25) and resistance value RL of resistors R11 and R12, differential voltage vo output between terminals To and To′ is represented by the following equation.

$${v}_{0} = {v}_{01} - {v}_{02} = \frac{4 \cdot sinh ( \frac{{v}_{1}}{2 {V}_{T}} ) \cdot sinh ( \frac{{v}_{2}}{2 {V}_{T}} ) \cdot {I}_{o} \cdot {R}_{L}}{4 \cdot {( [ cosh ( \frac{{v}_{1}}{2 {V}_{T}} ) ] )}^{2} + 4 \cdot cosh ( \frac{{v}_{1}}{2 {V}_{T}} ) \cdot cosh ( \frac{{v}_{2}}{2 {V}_{T}} ) + 1} \qquad ( 26 )$$

Here, consider the case when input differential voltage v1 and input differential voltage v2 are much smaller than said thermal voltage VT, that is, when |v1/2VT|<<1 and |v2/2VT|<<1. In this case, the hyperbolic functions of Equation (26) can be represented approximately as follows.

$$\begin{matrix}sinh ( \frac{{v}_{1}}{2 {V}_{T}} ) \approx ( \frac{{v}_{1}}{2 {V}_{T}} ) & ( 27 ) \\ cosh ( \frac{{v}_{1}}{2 {V}_{T}} ) \approx 1 & ( 28 ) \\ sinh ( \frac{{v}_{2}}{2 {V}_{T}} ) \approx ( \frac{{v}_{2}}{2 {V}_{T}} ) & ( 29 ) \\ cosh ( \frac{{v}_{2}}{2 {V}_{T}} ) \approx 1 & ( 30 )\end{matrix}$$

By substituting Equations (27)-(30) into Equation (26) and rearranging, one gets the following equation.

$${v}_{0} = {v}_{01} - {v}_{02} = \frac{4 \cdot ( \frac{{v}_{1}}{2 {V}_{T}} ) \cdot ( \frac{{v}_{2}}{2 {V}_{T}} ) \cdot {I}_{o} \cdot {R}_{L}}{4 + 4 + 1} = \frac{{I}_{o} \cdot {R}_{L}}{9 \cdot {( {V}_{T} )}^{2}} \cdot ( {v}_{1} \cdot {v}_{2} ) \qquad ( 31 )$$

In Equation (31), because current lo, resistance RL and thermal voltage VT are constants, output differential voltage vo becomes proportional to the product of input differential voltage v1 and input differential voltage v2.

Also, because a multiplier is usually used when one of the input signals is a small signal, while the other input signal is a large signal, consider the case when |v1/2VT|<<1 and |v2/2VT|>>1.

Because |v1/2VT|<<1, the following approximate relationships are established.

$$\begin{matrix}sinh ( \frac{{v}_{1}}{2 {V}_{T}} ) \approx ( \frac{{v}_{1}}{2 {V}_{T}} ) & ( 32 ) \\ cosh ( \frac{{v}_{1}}{2 {V}_{T}} ) \approx 1 & ( 33 )\end{matrix}$$

By substituting Equations (32) and (33) into Equation (26), one gets the following equation.

$${v}_{0} \approx \frac{4 \cdot ( \frac{{v}_{1}}{2 {V}_{T}} ) \cdot sin h ( \frac{{v}_{2}}{2 {V}_{T}} ) \cdot {I}_{O} \cdot {R}_{L}}{4 \times 4 \cdot cos h ( \frac{{v}_{2}}{2 {V}_{T}} ) + 1} \qquad ( 34 )$$

Also, as |v2/2VT|>>1, the following approximation can be used for the denominator of Equation (34).

$$4 + 4 \cdot cos h ( \frac{{v}_{2}}{2 {V}_{T}} ) + 1 \approx 4 \cdot cos h ( \frac{{v}_{2}}{2 {V}_{T}} ) \qquad ( 35 )$$

By substituting Equation (35) into Equation (34), one gets output differential voltage vo as follows.

$${v}_{0} \approx \frac{4 \cdot ( \frac{{v}_{1}}{2 {V}_{T}} ) \cdot sinh ( \frac{{v}_{2}}{2 {V}_{T}} ) \cdot {I}_{O} \cdot {R}_{L}}{4 \cdot cosh ( \frac{{v}_{2}}{2 {V}_{T}} )} \approx ( \frac{{v}_{1}}{2 {V}_{T}} ) \cdot tanh ( \frac{{v}_{2}}{2 {V}_{T}} ) \cdot {I}_{O} \cdot {R}_{L} \qquad ( 36 )$$

When v2/2VT >>1, one has

tanh(v2/2VT)≈1

When v2/2VT <<−1, one has

tanh(v2/2VT)≈−1

Consequently, Equation (36) can be rewritten approximately as follows.

$$\begin{matrix}{v}_{0} = ( \frac{{I}_{O} \cdot {R}_{L}}{2 {V}_{T}} ) \cdot {v}_{1} when {v}_{2} / 2 {V}_{T} >> 1 & ( 37 ) \\ {v}_{0} = - ( \frac{{I}_{O} \cdot {R}_{L}}{2 {V}_{T}} ) \cdot {v}_{1} when {v}_{2} / 2 {V}_{T} << -1 & ( 38 )\end{matrix}$$

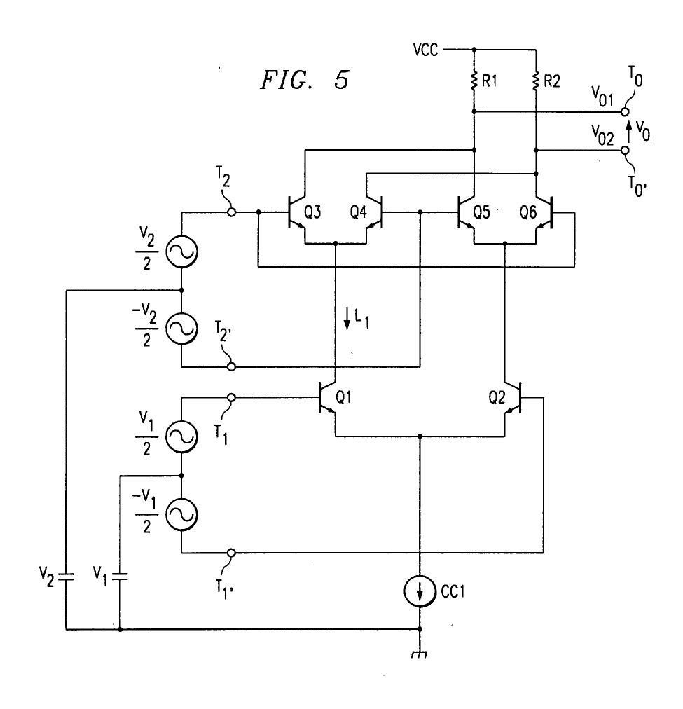

As can be seen from Equations (37) and (38), the magnitude of output differential voltage vo is proportional to input differential voltage v1, and the sign of output differential voltage vo is inverted corresponding to input differential voltage v2. Consequently, it functions as a multiplier in the same way as the Gilbert cell shown in FIG. 5.

Also, for the multiplier shown in FIG. 1, when conventional current mirror circuits are used in constant current circuit CC11 and constant current circuit CC12, the maximum amplitude ΔVomax of the signal that can be output to output terminal To and output terminal To′ becomes

ΔVomax≦Vcc−2Vce

and the amplitude of the output signal is larger than that of the Gilbert cell shown in FIG. 5 by collector-emitter voltage Vce of one transistor. That is, stable operation can be executed at a power source voltage lower by said voltage than that of the Gilbert cell.

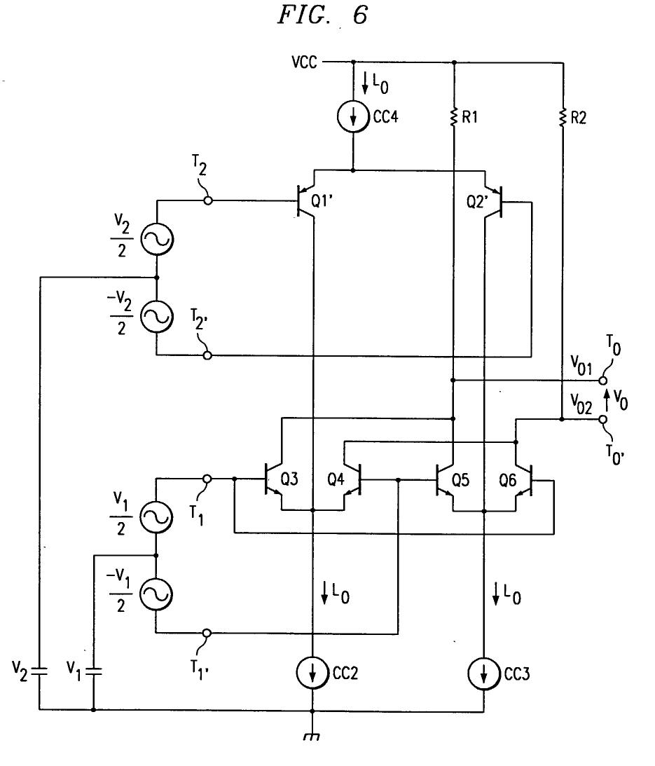

Also, the multiplier shown in FIG. 1 does not use pnp transistors. Consequently, the frequency characteristics are better than those of the multiplier shown in FIG. 6.

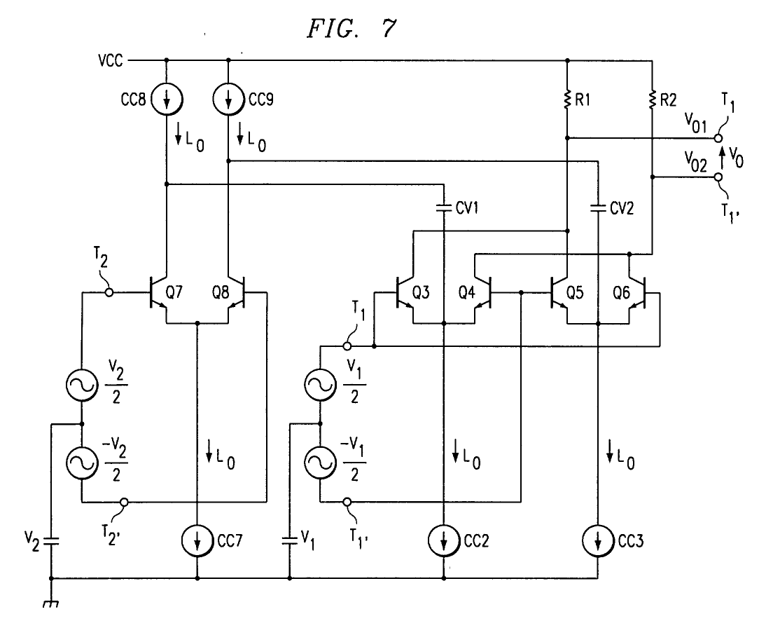

In addition, in the multiplier shown in FIG. 1, there are only two constant current circuits, and these circuits have a constant current flow in them with respect to the same potential (reference potential GND). Consequently, even when conventional current mirror circuits, etc. are used as the constant current circuits, it is still possible for their currents to be in agreement with each other at high precision. Consequently, the circuit constitution can be simplified as compared to that of the conventional multipliers shown in FIGS. 6 and 7.

In the following, other example constitutions of embodiment of this invention will be considered.

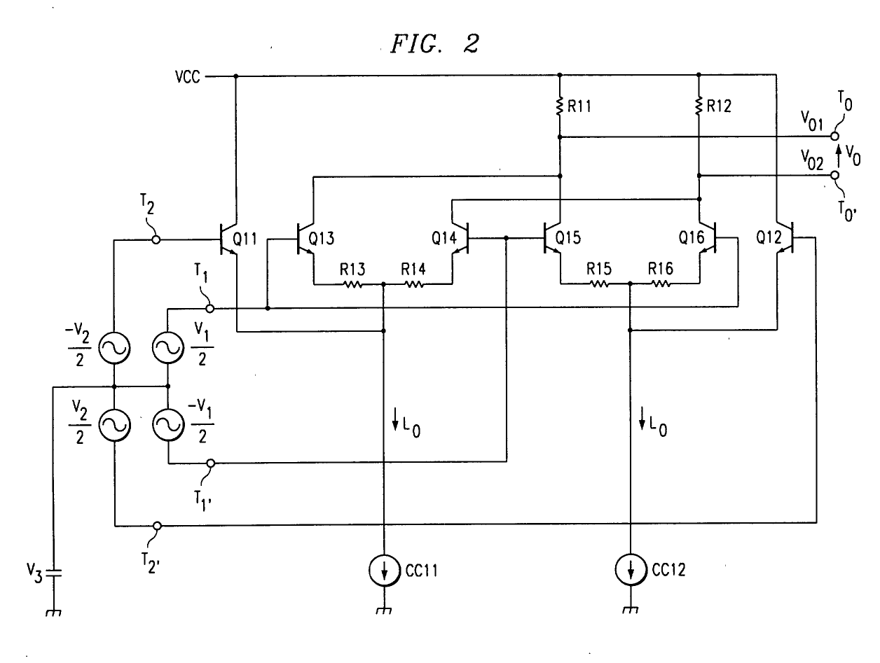

FIG. 2 is a schematic circuit diagram illustrating an example constitution that allows expansion of the input range of differential voltage v1 in the multiplier shown in FIG. 1.

The part numbers in FIG. 2 are the same as those used in FIG. 1. Also, in FIG. 2, R13-R16 represent resistors.

As shown in FIG. 2, resistors R13 and R14 are inserted in series in the connecting lines between the emitters of npn transistor Q13 and npn transistor Q14 and constant current circuit CC11, respectively. Also, resistors R15 and R16 are inserted in series in the connecting lines between the emitters of npn transistor Q15 and npn transistor Q16 and constant current circuit CC12, respectively.

Because a portion of differential voltage v1 is applied on said resistors that are inserted in series with emitters, it is possible to expand the range of input of differential voltage v1 where npn transistor Q13-npn transistor Q16 can work in the unsaturated region.

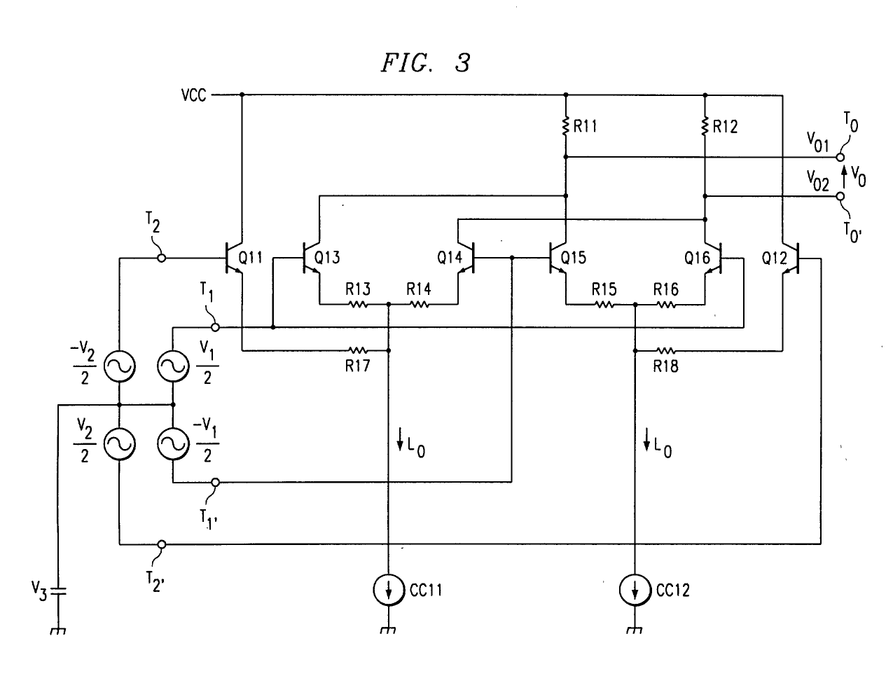

FIG. 3 is a schematic circuit diagram illustrating an example constitution that can expand the range of input of differential voltage v2 in the multiplier shown in FIG. 2.

The part numbers in FIG. 3 are the same as those used in FIG. 2. Also, in FIG. 3, R17 and R18 represent resistors.

As shown in FIG. 3, resistor R17 is inserted in series in the connecting line between npn transistor Q11 and constant current circuit CC11. Also, resistor R18 is inserted in series in the connecting line between npn transistor Q12 and constant current circuit CC12.

Because a portion of differential voltage v2 is applied on said resistors that are inserted in series with emitters, it is possible to expand the range of input of differential voltage v1 where npn transistor Q11 and npn transistor Q12 can work in the unsaturated region.

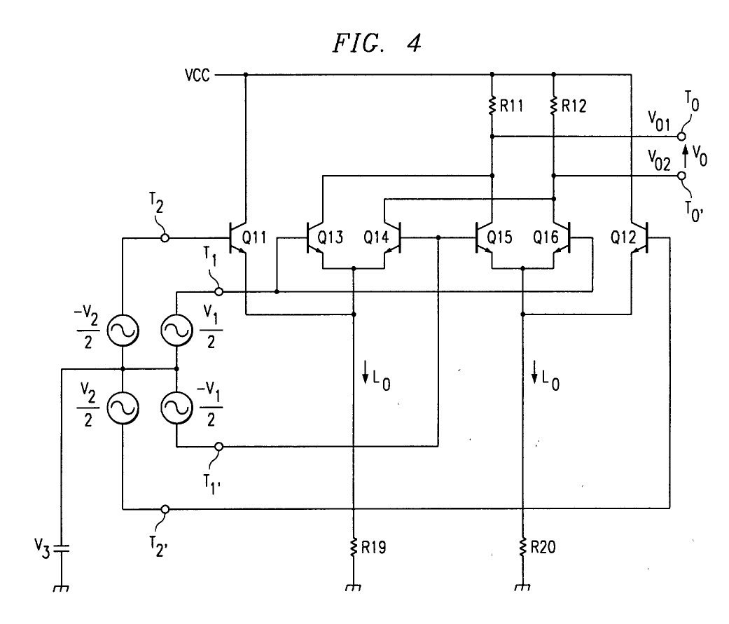

FIG. 4 is a schematic circuit diagram illustrating an example constitution that replaces constant current circuit CC11 and constant current circuit CC12 with resistors in the multiplier shown in FIG. 1.

The part numbers in FIG. 4 are the same as those in FIG. 1. Also, in FIG. 4, R19 and R20 represent resistors.

As shown in FIG. 4, even when constant current circuit CC11 and/or constant current circuit CC12 are replaced by resistors, when the resistance values of said resistors are sufficiently large, they can be considered to be constant current circuits. Consequently, the multiplier function can be maintained. Also, compared with constant current circuits using transistors, operation is possible under an even lower power source voltage. For example, even if the DC bias voltage V3 applied on the bases of npn transistor Q11-npn transistor Q13 is 1 V and the power source voltage Vcc is set at about 1.5 V, the multiplier still can work.

As explained above, for the multiplier shown in FIG. 1, differential voltage v1 is input to the bases of npn transistor Q13 and npn transistor Q14, and differential voltage v1 is input to the bases of npn transistor Q15 and npn transistor Q16. One voltage of differential voltage v2 is input to the base of npn transistor Q11, and the other voltage of the differential voltage v2 is input to the base of npn transistor Q12. In constant current circuit CC11, control is performed such that the sum of the emitter currents of npn transistor Q11, npn transistor Q13 and npn transistor Q14 becomes constant current Io. In constant current circuit CC12, control is performed such that the sum of the emitter currents of npn transistor Q12, npn transistor Q15 and npn transistor Q16 becomes constant current Io. The collectors of npn transistor Q13 and npn transistor Q15, which output collector currents that vary in opposite direction with respect to change in differential voltage v1, are connected to each other at terminal To. The collectors of npn transistor Q14 and npn transistor Q16, which output collector currents that vary in opposite direction with respect to change in differential voltage v1, are connected to each other at terminal To′.

In the aforementioned constitution, it is possible for the differential signal output from terminal To and terminal To′ to be approximately proportional to the product of differential voltage v1 and differential voltage v2. Also, a multiplier function can be displayed even at a power source voltage lower than that of the Gilbert cell shown in FIG. 5. In addition, because no pnp transistors are used in this case, it is possible to improve the frequency characteristics as compared to that of the multiplier shown in FIG. 6. Also, the constitution can be simplified as compared to that of the multipliers shown in FIGS. 6 and 7.

This invention is not limited to the aforementioned embodiments. Various modifications that are well known by specialists can be made.

For example, transistors used for embodiment are not limited to npn transistors. Other types of transistors may also be used.

For the multiplier of this invention, first of all, a multiplication operation can be performed at a power source voltage lower than that of the Gilbert cell and with a constitution simpler than the prior art. Second, a multiplication operation can be realized at a power source voltage lower than that needed for the Gilbert cell, and without using pnp transistors.

1. A type of multiplier characterized by the fact that it has the following parts:
a first transistor pair having a first transistor and a second transistor on which a first differential signal is applied;
a second transistor pair having a third transistor and a fourth transistor on which said first differential signal is applied;
a fifth transistor on which one signal of a second differential signal is applied;
a sixth transistor on which the other signal of said second differential signal is applied;
a first current feeding circuit for feeding current to said first transistor, second transistor, and fifth transistor;
a second current feeding circuit for feeding current to said third transistor, fourth transistor and sixth transistor;
a first resistor connected to said first transistor and fourth transistor having said first differential signal applied on them;
and a second resistor connected to said second transistor and third transistor having said first differential signal applied on them.

2. The multiplier described in claim 1 characterized by the fact that it has the following parts:
a third resistor connected between said first transistor and said first current feeding circuit;
a fourth resistor connected between said second transistor and said first current feeding circuit;
a fifth resistor connected between said third transistor and said second current feeding circuit;
and a sixth resistor connected between said fourth transistor and said second current feeding circuit.

3. The multiplier described in claim 2 characterized by the fact that it has
a seventh resistor connected between said fifth transistor and said first current feeding circuit;
and an eighth resistor connected between said sixth transistor and said second current feeding circuit.

4. The multiplier described in claim 1, 2, or 3 characterized by the fact that said first and second current feeding circuits are constant current circuits.
